(19) United States
(12) Patent Application Publication
(10) Pub. No.: US 2020/0026433 A1
(43) Pub. Date: Jan. 23, 2020

(54) STORAGE AGNOSTIC APPLICATION-CONSISTENT SNAPSHOT AND REPLICATION

(71) Applicant: Catalogic Software, Inc., Woodcliff Lake, NJ (US)

(72) Inventor: Ranjith Govindan, Paramus, NJ (US)

(21) Appl. No.: 16/588,372

(22) Filed: Sep. 30, 2019

Related U.S. Application Data
(63) Continuation of application No. PCT/US18/25565, filed on Mar. 30, 2018.
(60) Provisional application No. 62/480,020, filed on Mar. 31, 2017.

(51) Int. Cl. G06F 3/06; G06F 11/14; G06F 16/27

(52) U.S. Cl. CPC G06F 3/065; G06F 3/0659; G06F 3/0619; G06F 2201/84; G06F 11/1451; G06F 16/27; G06F 3/0673

(57) ABSTRACT

Storage-agnostic application-consistent snapshot and replication is provided. In various embodiments, a snapshot command is issued to a volume snapshot service. The volume snapshot service is thereby directed to place one or more applications in backup mode. A list of LUNs to be snapshotted is retrieved from the volume snapshot service. A snapshot command is issued to one or more storage system underlying the LUNs on the list. Upon completion of the snapshot command to the one or more storage systems, control is returned to the volume snapshot service.

### CROSS-REFERENCE TO RELATED APPLICATIONS

This application claims the benefit of Provisional Application No. 62/480,020, filed Mar. 31, 2017, which is hereby incorporated by reference in its entirety.

### BACKGROUND

Embodiments of the present disclosure relate to snapshotting, and more specifically, to storage-agnostic application-consistent snapshot and replication.

### BRIEF SUMMARY

According to embodiments of the present disclosure, methods of and computer program products for snapshotting are provided. In various embodiments, a snapshot command is issued to a volume snapshot service. The volume snapshot service is thereby directed to place one or more applications in backup mode. A list of LUNs to be snapshotted is retrieved from the volume snapshot service. A snapshot command is issued to one or more storage system underlying the LUNs on the list. Upon completion of the snapshot command to the one or more storage systems, control is returned to the volume snapshot service.

In some embodiments, the one or more applications comprise a database application. In some embodiments, the LUNs to be snapshotted correspond to one or more volumes backing the one or more applications. In some embodiments, the LUNs are replicated from the one or more storage system to secondary storage with a point in time copy.

### BRIEF DESCRIPTION OF THE SEVERAL VIEWS OF THE DRAWINGS

FIG. 1 illustrates a system for providing snapshots according to embodiments of the present disclosure.

FIG. 2 illustrates agent interaction within a system according to the present disclosure.

FIG. 3 illustrates a system for providing snapshots according to embodiments of the present disclosure.

FIG. 4 illustrates a method for snapshotting according to embodiments of the present disclosure.

FIG. 5 depicts a computing node according to embodiments of the present disclosure.

### DETAILED DESCRIPTION

Application consistent snapshots on Windows may be provided using the Windows VSS framework. In such cases, snapshots are taken using VSS snapshot providers. Windows may provide native software snapshot functionality, where each storage system vendor is responsible for implementing snapshots for their storage systems. Various storage vendors may offer a provider for taking snapshots on the primary storage systems. However, to create a secondary copy, the equivalent functionality is not supported in various storage systems. Some storage systems may allow the replication of primary snapshots to secondary storage systems. However, many vendors only support volume replication without replicating the snapshots. This limits the ability to create in-place, application-consistent copies on secondary storage systems.

The present disclosure addresses this and other limitations of alternative solutions for storage arrays. The present disclosure provides systems and methods that works with any storage system to create in-place application-consistent snapshots on both primary and secondary storage systems.

In various embodiments, an application-consistent snapshot is created and replication is provided of in-place copies on primary and secondary storage systems, irrespective of their underlying replication technology. Various alternative storage systems solutions support only the creation of primary copies on storage systems and are not designed to create secondary copies.

A snapshot provides a read-only copy of a data set frozen at a point in time while allowing applications to continue writing to their data. This allows high data availability systems to perform backups without downtime. Some snapshot implementations can create snapshots in O(1) time. Accordingly, the time and I/O needed to create the snapshot does not increase with the size of the data set. The time and I/O required for a direct backup is proportional to the size of the data set. In some systems, once the initial snapshot is taken of a data set, subsequent snapshots copy the changed data only, and use a system of pointers to reference the initial snapshot. This method of pointer-based snapshots consumes less disk capacity than if the data set was repeatedly cloned.

In NTFS, access to snapshots is provided by the Volume Shadow-copying Service (VS S) in Windows XP and Windows Server 2003, and by Shadow Copy in Windows Vista. VS S allows taking manual or automatic backup copies or snapshots of computer files or volumes, even when they are in use. It is implemented as a Windows service called the Volume Shadow Copy service. Shadow Copies can be created on local and external (removable or network) volumes by any Windows component that uses this technology.

The core component of shadow copy is the Volume Shadow Copy service, which initiates and oversees the snapshot creation process. The components that perform all the necessary data transfer are called providers. Software and hardware providers may thus be provided and registered them with Volume Shadow Copy service. Each provider has a maximum time to complete the snapshot generation, which in some embodiments is 10 seconds.

The Volume Shadow Copy service also accommodates pluggable writers. As described above, the aim of Shadow Copy is to create consistent reliable snapshots. In some circumstances, completing all pending file change operations is not sufficient. It may be necessary to complete a series of inter-related changes to several related files. For example, when a database application transfers a piece of data from one file to another, it needs to delete it from the source file and create it in the destination file. Hence, a snapshot must not be created between the first deletion and the subsequent creation in order to maintain data consistency. Application-specific writers are responsible for enforcing this semantic consistency. In some embodiments, a pluggable writer has 60 seconds to establish a backup-safe state before providers start snapshot creation.

In computer storage, a logical unit number, or LUN, is a number used to identify a logical unit, which is a device addressed by the SCSI protocol or Storage Area Network protocols which encapsulate SCSI, such as Fibre Channel or iSCSI. A LUN may be used with any device which supports read/write operations, such as a tape drive, but is most often used to refer to a logical disk as created on a SAN. The term LUN may also be used to refer to the logical disk itself.

Systems and methods according to the present disclosure provide a universal, in-place snapshot provider, that can support any storage systems. Moreover, the systems and methods provided herein enable a storage-agnostic in-place snapshot provider.

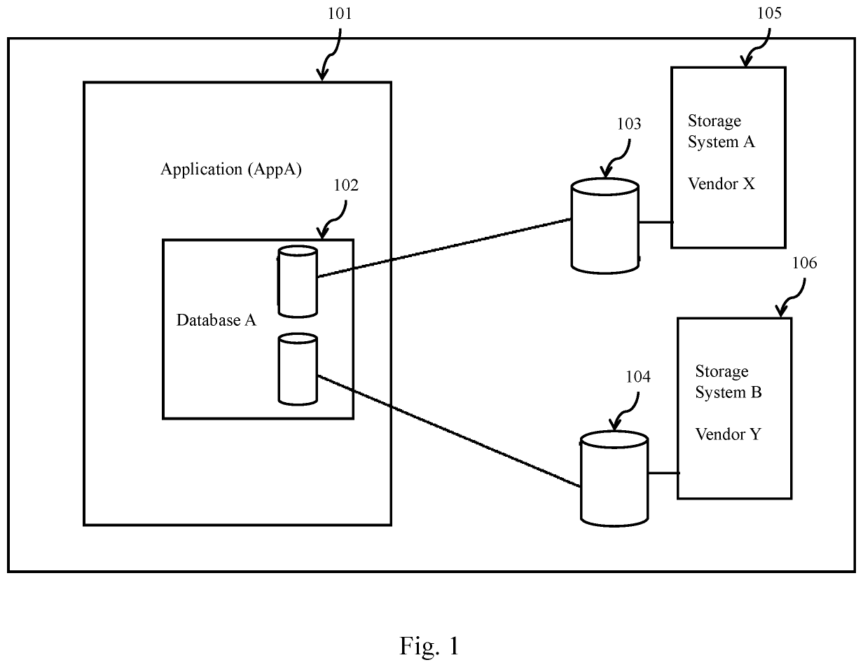

With reference now to FIG. 1, a system for providing snapshots according to embodiments of the present disclosure is illustrated. Application 101 (AppA) includes database 102 (Database A). Database 102 keeps its files on LUN A 103 and LUN B 104. In particular, database files are stored on LUN A 103 while log files are stored on LUN B 104. LUN A 103 is mapped from Storage System A 105 and LUN B 104 is mapped from Storage System B 106. In this example, Storage System A 105 is from Vendor X and Storage System B 106 is from Vendor Y. Accordingly, the application database is hosted on two volumes backed by LUNs provided by different storage vendors.

During the copy creation, data protection software according to the present disclosure (e.g., ECX) injects a VSS Requestor and VSS Snapshot provider to the Windows VSS system. The data protection software discovers the applications configuration and storage layout and issues a SNAPSHOT command to the VSS Requestor. The VSS Requestor on a Windows system in turn requests the VSS framework to snapshot the application database. The VSS framework will contact the application's writer and put the application in backup mode and request the VSS Snapshot provider to take the snapshot.

The VSS Snapshot provider contacts the data protection software with the list of LUNs to be snapshotted or replicated. At this point, the data protection software will issue SNAPSHOT or REPLICATE commands to Storage System A 105 for LUN A 103 and Storage System B 106 for LUN B 104 depending on storage workflow defined as part of policy. On successful completion of creation of the snapshot or establishing the replication relationship, it will return the control back to the VSS Snapshot provider. The process ensures that this will be done well within the 10 second window enforced by Windows.

VSS will request the writer to take the application out of backup mode and return the control back to the Requestor. Requestor will relay this back to the data protection software.

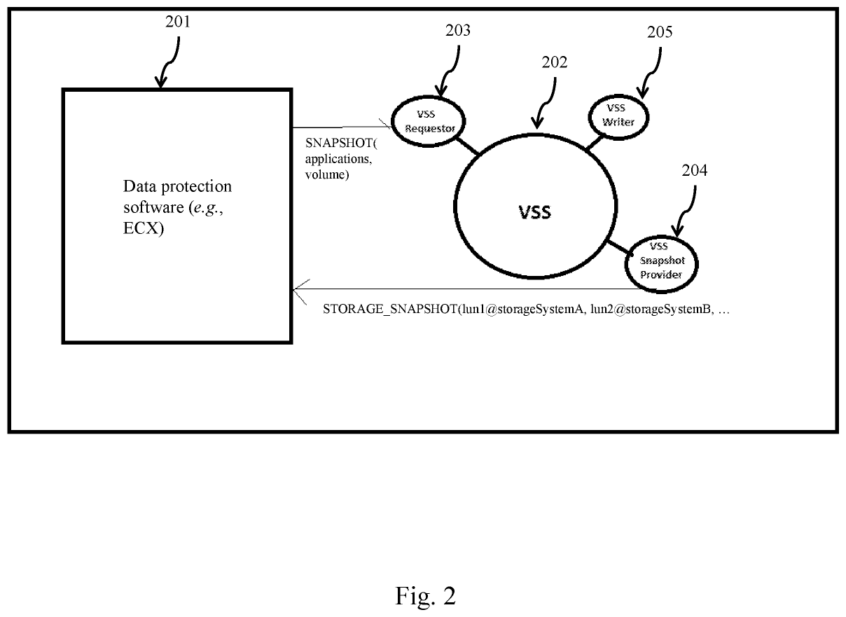

With reference now to FIG. 2, agent interaction within a system according to the present disclosure is illustrated, in particular agent interaction between data protection software, the VSS requestor, and the VSS snapshot provider. This figure represents how the communication and layout between the data protection software 201 (e.g., ECX) and Windows (or other operating system) make application snapshot and replicated copies for LUNs from two storage systems (e.g., A 105 and B 106).

In general, a Volume Snapshot Service (VSS) allows taking manual or automatic backup copies or snapshots of computer files or volumes, even when they are in use. It may be implemented as a Windows service or comparable component on another operating systems. In general, VSS operates at the block level of volumes. However, it will be appreciated that the present disclosure may be applied to file-level backup. In general, a snapshot is a read-only point-in-time copy of the volume. Snapshots allow the creation of consistent backups of a volume, ensuring that the contents do not change and are not locked while the backup is being made.

Within a VSS architecture 202, the components that perform all the necessary data transfer are called providers. Software or hardware providers 204 may be registered with the VSS 202, which initiates and oversees the snapshot creation process. VSS writers 205 may also be registered with the VSS 202. In some cases, consistent reliable snapshots cannot be generated by completing all pending file change operations. Thus, it may be necessary to complete a series of inter-related changes to several related files. For example, when a database application transfers a piece of data from one file to another, it may delete the data from the source file and create the data in the destination file. Hence, a snapshot should not occur between the first deletion and the subsequent creation. It should occur before the deletion or after the creation. Enforcing this semantic consistency is delegated to VSS writers 205. Each writer is application-specific and has a fixed time to establish a backup-safe state before providers start snapshot creation. In some embodiments, the time limit is 60 seconds. If the VSS does not receive acknowledgement of success from the corresponding writers with this time, the operation fails.

According to various embodiments of the present disclosure, data protection software 201 (e.g., ECX) sends a snapshot request to VSS 202 via VSS requestor 203. In some embodiments, the request includes application and volume identifiers. VSS snapshot provider 204 returns LUN data, including the LUN identifier. The above processes establish an application-consistent copy point on either primary or secondary storage, which can be used for e.g., recovery, DevOps, or Analytics using native array capabilities.

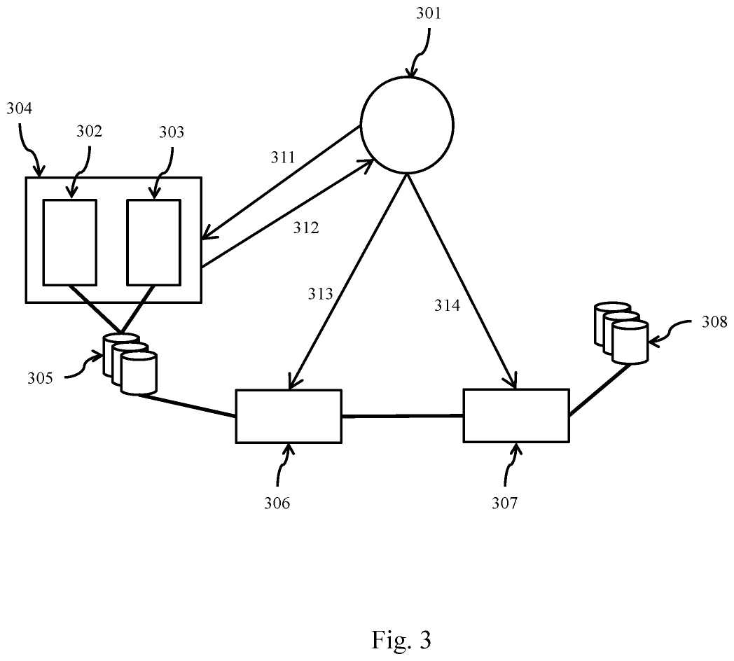

Referring now to FIG. 3, a system for providing snapshots according to embodiments of the present disclosure is illustrated. In various embodiments, data protection software/management server (e.g., ECX) 301 creates application consistent snapshots by communicating with database servers 302 . . . 303. In some embodiments, database servers 302 . . . 303 may be SQL servers. In this example, database servers 302 . . . 303 back application 304. Database servers 302 . . . 303 in turn are backed by one or more source volume or snapshot 305 located on primary physical storage 306. At 311, the VSS as described above puts application 304 in backup mode. At 312, a VSS hardware provider calls management server 301 to take a storage snapshot or replicate a point in time copy. As noted above, in certain embodiments, the underlying operating system provide a 10 second window for this operation. At 313, management server 301 calls primary physical storage 306 to create a snapshot. At 314, management server 301 calls secondary physical storage 307 to replicate a volume from primary storage with a point in time copy. Replicated volumes and snapshots 308 are backed by physical secondary storage 307.

Once a snapshot is created or replication is initiated, control returns to the VSS hardware provider. The VSS hardware provider returns the call to the VSS requestor (e.g., ECX agent). Management server 301 catalogs the primary snapshot or replicated volume snapshot.

A management server (e.g., ECX) as set forth above simplifies SQL Server copy management by enabling administrators to orchestrate application-consistent copy creation, cloning and recovery in minutes, instead of hours or days. This copy management leverages the snapshot and replication features of the underlying storage platform to rapidly create, replicate, clone, and restore copies of databases (e.g., SQL server) efficiently in both time and space.

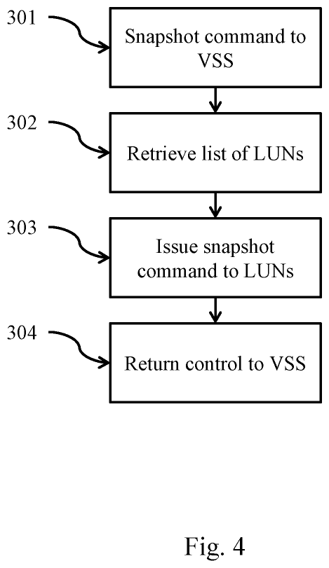

Referring now to FIG. 4, a method of snapshotting according to embodiments of the present disclosure is illustrated. At 401, a snapshot command is issued to a volume snapshot service. The volume snapshot service is thereby directed to place one or more applications in backup mode. At 402, a list of LUNs to be snapshotted is retrieved from the volume snapshot service. At 403, a snapshot command is issued to one or more storage system underlying the LUNs on the list. At 404, upon completion of the snapshot command to the one or more storage systems, control is returned to the volume snapshot service.

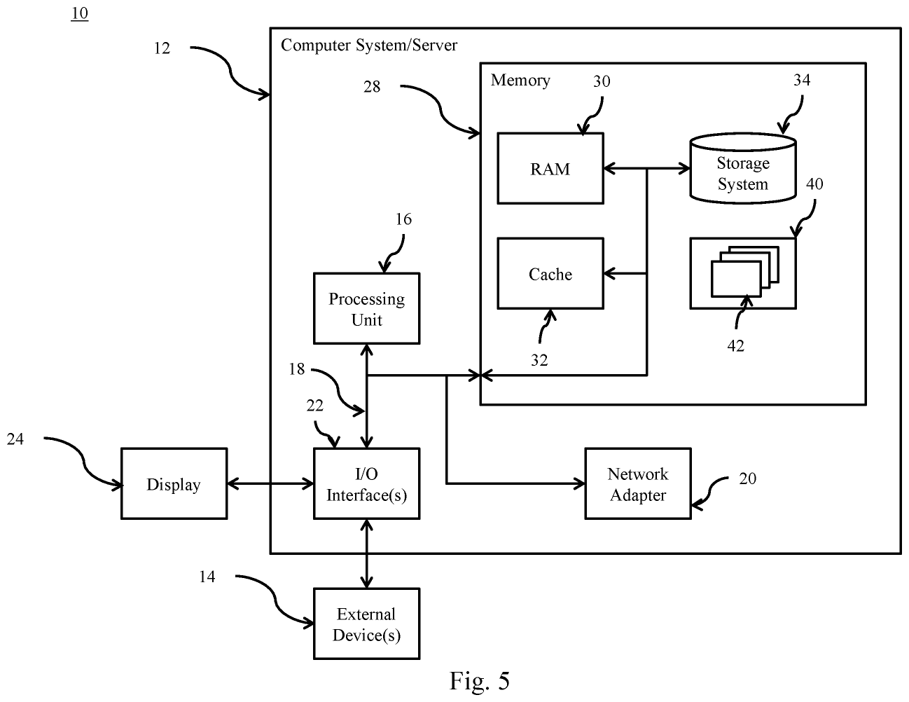

Referring now to FIG. 5, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may include a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
issuing a snapshot command to a volume snapshot service, and thereby directing the volume snapshot service to place one or more applications in backup mode;
retrieving from the volume snapshot service a list of LUNs to be snapshotted;
issuing a snapshot command to one or more storage system underlying the LUNs on the list;
upon completion of the snapshot command to the one or more storage systems, returning control to the volume snapshot service.

2. The method of claim 1, wherein the one or more applications comprise a database application.

3. The method of claim 1, wherein the LUNs to be snapshotted correspond to one or more volumes backing the one or more applications.

4. The method of claim 1, further comprising:
replicating the LUNs from the one or more storage system to secondary storage with a point in time copy.

5. A system comprising:
one or more storage system;
a computing node, the computing node comprising a computer readable storage medium having program instructions embodied therewith, the program instructions executable by a processor to cause the processor to perform a method comprising:
issuing a snapshot command to a volume snapshot service, and thereby directing the volume snapshot service to place one or more applications in backup mode;
retrieving from the volume snapshot service a list of LUNs to be snapshotted;
issuing a snapshot command to the one or more storage system, the one or more storage system underlying the LUNs on the list;
upon completion of the snapshot command to the one or more storage systems, returning control to the volume snapshot service.

6. The system of claim 1, wherein the one or more applications comprise a database application.

7. The system of claim 1, wherein the LUNs to be snapshotted correspond to one or more volumes backing the one or more applications.

8. The system of claim 1, further comprising:
replicating the LUNs from the one or more storage system to secondary storage with a point in time copy.

9. A computer program product for snapshotting, the computer program product comprising a computer readable storage medium having program instructions embodied therewith, the program instructions executable by a processor to cause the processor to perform a method comprising:
issuing a snapshot command to a volume snapshot service, and thereby directing the volume snapshot service to place one or more applications in backup mode;
retrieving from the volume snapshot service a list of LUNs to be snapshotted;
issuing a snapshot command to one or more storage system underlying the LUNs on the list;
upon completion of the snapshot command to the one or more storage systems, returning control to the volume snapshot service.

10. The computer program product of claim 9, wherein the one or more applications comprise a database application.

11. The computer program product of claim 9, wherein the LUNs to be snapshotted correspond to one or more volumes backing the one or more applications.

12. The computer program product of claim 9, the method further comprising:
replicating the LUNs from the one or more storage system to secondary storage with a point in time copy.
